(19) United States
(12) Patent Application Publication
(10) Pub. No.: US 2025/0026956 A1
(43) Pub. Date: Jan. 23, 2025

(54) INSULATING AND FLAME RETARDANT POLYAMIDE COMPOSITION FOR COVERING AN ELECTRIC BATTERY INTERCONNECTING BAR

(71) Applicant: ARKEMA FRANCE, COLOMBES (FR)

(72) Inventors: Olivier MASSOT, Serquigny (FR); Florent ABGRALL, Serquigny (FR); Marjorie MARCOURT, Serquigny (FR)

(73) Assignee: ARKEMA FRANCE, COLOMBES (FR)

(21) Appl. No.: 18/715,407

(22) PCT Filed: Dec. 1, 2022
(86) PCT No.: PCT/FR2022/052209

§ 371 Date: May 31, 2024

(30) Foreign Application Priority Data
Dec. 2, 2021 (FR) FR2112829

(51) Int. Cl. C09D 177/02; C08K 5/56; C09D 5/18; H01M 50/143; H01M 50/24

(52) U.S. Cl. CPC C09D 177/02; C09D 5/18; H01M 50/143; H01M 50/24; C08K 5/56; H01M 2220/20

(57) ABSTRACT

The present invention relates to a flame retarded insulating composition for covering electric battery busbars, comprising by weight: (a) from 30 to 65%, more particularly from 30 to 63.9%, in particular from 30 to 60%, of at least one semi-crystalline aliphatic polyamide, (b) from 15 to 40%, more particularly from 15 to 30%, of at least one semi-aromatic polyamide, (c) from 15 to 30%, more particularly from 20 to 25%, of at least one phosphinate flame retardant, (d) from 5 to 20%, more particularly from 5 to 15%, of at least one functionalized polyolefin, (e) from 0 to 6%, more particularly from 1 to 6%, in particular between 2 and 4%, of at least one plasticizer, (f) from 0 to 10%, more particularly 10 from 0.1 to 5%, of at least one additive, the sum of the constituents (a) to (f) being equal to 100%.

The invention pertains to insulating and flame retarded polyamide compositions for covering electric battery busbars.

### PRIOR ART

In the electric vehicle sector, connectors called busbars (interconnect bars) are present for circulating high-intensity current inside and outside batteries. These bars must be protected by an insulating coating resistant to mechanical stresses and to aging. In view of the consequences a fire would have in such an environment, the coating must also exhibit excellent fire resistance.

A number of processes exist for producing busbars. The main one is the extrusion of the polymer around the central copper strip. This structure is then cut and bent (at ambient temperature) to take on the shape required by the arrangement of the vehicle. For the most complex busbar shapes, powder coating can also be used with specific grades.

The technical problem associated with the battery busbar application is that of forming a thin polymer layer that is fire resistant (UL94 V0 at 0.8 mm), while maintaining a high level of flexibility to accommodate the deformation of the busbars. During bending, a material that is too rigid forms cracks on the external face and “waves” or “beads” on the internal face, phenomena which are unacceptable for the application.

The behavior at the plasticity threshold of the material is therefore crucial. Low stresses at the threshold and a large elongation at the threshold are desirable.

The deformation levels of these coatings remain low but the material must nevertheless have an elongation at break >50%. Good abrasion resistance is also necessary for this application.

The coating must also act as an electrical insulator, which translates into properties such as breakdown voltage, dielectric strength and comparative tracking index (CTI)>600 V. This insulation must be preserved during accelerated thermal aging at possibly up to 150° C.

Lastly, the rheological properties of the alloy must be adapted to the extrusion of a thin polymer layer of the order of 0.5 mm.

The flame retardants most frequently used in polyamide (PA) compositions are those of the phosphinate class. Their mode of action and their thermal stability make them particularly suitable for polyamide matrices. Thus, document US 2006/0084734 describes phosphinate flame retardants and their preparation and document US 2005/0014874 describes examples of the use of these phosphinates in the flame retarding of an aromatic or semi-aromatic polyamide. This patent application provides information on the better fire resistance of semi-aromatic polyamides (PAP) compared with aliphatic PA, in the presence of phosphinate flame retardant.

Moreover, patent application EP 1741753 describes compositions of this type of flame retardant in a mixture of aliphatic and semi-aromatic PA in the presence of inorganic reinforcement (glass fiber). In this patent application, the phosphinate flame retardant is necessarily combined with a nitrogen synergist based on melamine.

Finally, in the railway field, patent application US20170037198 presents formulations based on plasticized and phosphinate-flame retarded PA12 with optionally polyolefin and/or PEBA impact modifiers.

Nevertheless, these various documents provide information on how to obtain a fire resistant PA or a ductile PA. However, it is difficult to obtain a product of low thickness which is ductile and fire resistant. In the prior art cited, only formulations with glass fibers have UL94 V0 at 0.8 mm. Alloys without glass fiber have UL94 for higher thicknesses. But the lower the thickness, the more difficult it is to resist fire.

Moreover, the prior art does not provide information on the combinations to be made within the formulation in order to simultaneously achieve the flexibility and the fire resistance required for the battery busbar application.

The present invention therefore relates to a flame retarded insulating composition for covering electric battery busbars, comprising by weight:
(a) from 30 to 65%, more particularly from 30 to 63.9%, in particular from 30 to 60%, of at least one semi-crystalline aliphatic polyamide,
(b) from 15 to 40%, in particular from 15 to 30%, of at least one semi-aromatic polyamide,
(c) from 15 to 30%, more particularly from 20 to 25%, of at least one phosphinate flame retardant,
(d) from 5 to 20%, more particularly from 5 to 15%, of at least one functionalized polyolefin,
(e) from 0 to 6%, more particularly from 1 to 6%, in particular between 2 and 4%, of at least one plasticizer,
(f) from 0 to 10%, more particularly from 0.1 to 5%, of at least one additive, the sum of the constituents (a) to (f) being equal to 100%.

The inventors have therefore found that a mixture of semi-crystalline aliphatic polyamides and semi-aromatic polyamides in particular proportions, combined with a phosphinate flame retardant and a functionalized polyolefin, both in an equally particular proportion, optionally with a plasticizer and additives, made it possible to constitute a composition exhibiting the criteria detailed above necessary for the battery busbar application.

The covering of the busbar by the composition of the invention allows the bar to be protected by an insulating coating which is resistant to fire and also to mechanical stresses and to aging.

Said busbar is located inside and/or outside electric batteries, more particularly electric batteries of a vehicle, more particularly of a motor vehicle.

### The Semi-Crystalline Aliphatic Polyamide (a)

Said at least one semi-crystalline aliphatic polyamide (a) is present at from 30 to 65%, more particularly from 30 to 63.9%, in particular from 30 to 60%, by weight in the composition.

Semi-crystalline polyamide is understood to mean a material which is generally solid at room temperature and which softens on an increase in temperature, more particularly after passing its glass transition temperature (Tg), and which can melt sharply when passing its so-called melting temperature (Tm), and which becomes solid again when the temperature decreases below its crystallization temperature.

The Tg, the Tc and the Tm are determined by differential scanning calorimetry (DSC) according to the standards 11357-2:2013 and 11357-3:2013 respectively.

The number-average molecular mass Mn of said semi-crystalline polyamide is preferably in a range from 10 000 to 85 000, in particular from 10 000 to 60 000, preferably from 10 000 to 50 000 and even more preferably from 12 000 to 50 000. These Mn values can correspond to inherent viscosities of greater than or equal to 0.8, as determined in m-cresol according to the standard ISO 307:2007, but changing the solvent (use of m-cresol in place of sulfuric acid and the temperature being 20° C.).

The nomenclature used to define polyamides is described in the standard ISO 1874-1:2011 “Plastics-Polyamide (PA) moulding and extrusion materials-Part 1: Designation”, in particular on page 3 (Tables 1 and 2) and is well known to those skilled in the art.

The term polyamide embraces both homopolyamides and copolyamides.

Said at least one aliphatic semi-crystalline polyamide is obtained from the polycondensation of at least one lactam, or from the polycondensation of at least one amino acid, or from the polycondensation of at least one diamine X with at least one dicarboxylic acid Y or mixtures thereof.

When said at least one aliphatic semi-crystalline polyamide is obtained from the polycondensation of at least one lactam, said at least one lactam may be chosen from a C8 to C18, preferably C10 to C18, more preferably C10 to C12 lactam. A C8 to C18 lactam is in particular decanolactam, undecanolactam and lauryllactam.

When said at least one aliphatic semi-crystalline polyamide is obtained from the polycondensation of at least one lactam, it may therefore comprise a single lactam or several lactams.

Advantageously, said at least one aliphatic semi-crystalline polyamide is obtained from the polycondensation of a single lactam and said lactam is chosen from lauryllactam and undecanolactam, advantageously lauryllactam.

When said at least one aliphatic semi-crystalline polyamide is obtained from the polycondensation of at least one amino acid, said at least one amino acid may be chosen from a C8 to C18, preferably C10 to C18, more preferably C10 to C12 amino acid.

A C8 to C18 amino acid is in particular 9-aminononanoic acid, 10-aminodecanoic acid, 10-aminoundecanoic acid, 12-aminododecanoic acid and 11-aminoundecanoic acid, as well as derivatives thereof, in particular N-heptyl-11-aminoundecanoic acid.

When said at least one aliphatic semi-crystalline polyamide is obtained from the polycondensation of at least one amino acid, it may therefore comprise a single amino acid or several amino acids.

Advantageously, said aliphatic semi-crystalline polyamide is obtained from the polycondensation of a single amino acid and said amino acid is chosen from 10-aminodecanoic acid, 11-aminoundecanoic acid and 12-aminododecanoic acid, advantageously 11-aminoundecanoic acid.

When said at least one aliphatic semi-crystalline polyamide is obtained from the polycondensation of at least one C6-C36, preferably C6-C18, preferably C6-C12, more preferably C10-C12 diamine X with at least one C6-C36, preferably C6-C18, preferably C6-C12, more preferably C10-C12 diacid Y, then said at least one diamine X is an aliphatic diamine and said at least one diacid Y is an aliphatic diacid.

The diamine may be linear or branched. Advantageously, it is linear.

Said at least one C6-C36 diamine X may be chosen in particular from 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine, octadecenediamine, eicosanediamine, docosanediamine and diamines obtained from fatty acids.

Advantageously, said at least one diamine X is C6-C18 and is chosen from 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine.

Advantageously, said at least one C6 to C12 diamine X is chosen in particular from 1,6-hexamethylenediamine, 1,7-heptamethylenediamine, 1,8-octamethylenediamine, 1,9-nonamethylenediamine, 1,10-decamethylenediamine, 1,11-undecamethylenediamine and 1,12-dodecamethylenediamine.

Advantageously, said at least one C6 to C12 diamine X is chosen in particular from 1,6-hexamethylenediamine, 1,7-heptamethylenediamine, 1,8-octamethylenediamine, 1,9-nonamethylenediamine, 1,10-decamethylenediamine, 1,11-undecamethylenediamine and 1,12-dodecamethylenediamine.

Advantageously, the diamine X used is C10 to C12, in particular chosen from 1,10-decamethylenediamine, 1,11-undecamethylenediamine and 1,12-dodecamethylenediamine.

Said at least one C6 to C36 dicarboxylic acid Y may be chosen from adipic acid, suberic acid, azelaic acid, sebacic acid, undecanedioic acid, dodecanedioic acid, brassylic acid, tetradecanedioic acid, pentadecanedioic acid, hexadecanedioic acid, octadecanedioic acid, and diacids obtained from fatty acids.

The diacid may be linear or branched. Advantageously, it is linear.

Advantageously, said at least one dicarboxylic acid Y is C6 to C18 and is chosen from adipic acid, suberic acid, azelaic acid, sebacic acid, undecanedioic acid, dodecanedioic acid, brassylic acid, tetradecanedioic acid, pentadecanedioic acid, hexadecanedioic acid and octadecanedioic acid.

Advantageously, said at least one dicarboxylic acid Y is C6 to C12 and is chosen from adipic acid, suberic acid, azelaic acid, sebacic acid, undecanedioic acid and dodecanedioic acid.

Advantageously, said at least one dicarboxylic acid Y is C10 to C12 and is chosen from sebacic acid, undecanedioic acid and dodecanedioic acid.

When said aliphatic semi-crystalline polyamide is obtained from the polycondensation of at least one diamine X with at least one dicarboxylic acid Y, it may therefore comprise a single diamine or several diamines and a single dicarboxylic acid or several dicarboxylic acids.

Advantageously, said aliphatic semi-crystalline polyamide is obtained from the polycondensation of a single diamine X with a single dicarboxylic acid Y.

In one embodiment, said at least one polyamide is a long-chain polyamide having a number of carbons per nitrogen atom of greater than or equal to 8, more particularly greater than or equal to 9, in particular greater than or equal to 10.

In another embodiment, said at least one semi-crystalline aliphatic polyamide is chosen from the polyamides PA610, PA612, PA1010, PA1012, PA11 and PA12.

Advantageously, said at least one semi-crystalline aliphatic polyamide is chosen from the polyamides PA1010, PA1012, PA11 and PA12, more particularly from PA11 and PA12, in particular PA11.

### The Semi-Aromatic Polyamide (b)

Said at least one semi-aromatic polyamide (b) is present at from 15 to 40%, more particularly from 15 to 30%, by weight in the composition.

In one embodiment, the semi-aromatic polyamide is a semi-crystalline semi-aromatic polyamide, in particular a semi-aromatic polyamide of formula X/YAr, as described in EP1505099, in particular a semi-aromatic polyamide of formula A/XT wherein A is chosen from a unit obtained from an amino acid, a unit obtained from a lactam and a unit of the formula (Ca diamine). (Cb diacid), where a is the number of carbon atoms of the diamine and b is the number of carbon atoms of the diacid, a and b are each between 4 and 36, advantageously between 9 and 18, the unit (Ca diamine) being chosen from linear or branched aliphatic diamines, cycloaliphatic diamines and alkylaromatic diamines and the unit (Cb diacid) being chosen from linear or branched aliphatic diacids, cycloaliphatic diacids and aromatic diacids;

X.T denotes a unit obtained from the polycondensation of a Cx diamine and terephthalic acid, with x representing the number of carbon atoms of the Cx diamine, x being between 5 and 36, advantageously between 9 and 18, in particular a polyamide of formula A/5T, A/6T, A/9T, A/10T or A/11T, A being as defined above, more particularly a polyamide chosen from a PA MPMDT/6T, a PA 11/10T, a PA 5T/10T, a PA 11/BACT, a PA 11/6T/10T, a PA MXDT/10T, a PA MPMDT/10T, a PA BACT/10T, a PA BACT/6T, a PA BACT/10T/6T, a PA 11/BACT/6T, PA 11/MPMDT/6T, PA 11/MPMDT/10T, PA 11/BACT/10T, a PA 11/MXDT/10T, an 11/5T/10T.

In particular, the semi-crystalline semi-aromatic polyamide is chosen from polyamide 11/5T or 11/6T or 11/10T, MXDT/10T, MPMDT/10T and BACT/10T.

T corresponds to terephthalic acid, MXD corresponds to m-xylylenediamine, MPMD corresponds to methylpentamethylenediamine and BAC corresponds to bis (aminomethyl) cyclohexane.

In one embodiment, the Cb diacid of unit A excludes itaconic acid.

In another embodiment, said at least one semi-aromatic polyamide is a polyamide of formula X₁Y, X₁Y being a repeating unit obtained from the polycondensation of a diamine (X₁) chosen from an arylamine, and of at least one aliphatic dicarboxylic acid (Y) as defined above.

In one embodiment, the aliphatic dicarboxylic acid (Y) of the semi-aromatic polyamide of formula X₁Y excludes itaconic acid.

Advantageously, in this embodiment, the arylamine is chosen from meta-xylylenediamine (MXD, CAS No.: 1477-55-0) or para-xylylenediamine (PXD, CAS No.: 539-48-0).

In another embodiment, said at least one semi-aromatic polyamide is a polyamide of formula MXDY in which MXD corresponds to meta-xylylenediamine and Y is a C6 to C18, in particular C9 to C18, more particularly C9 to C12, aliphatic dicarboxylic acid.

Advantageously, said semi-aromatic polyamide of formula MXDY is chosen from MXD6, MXD10 and MXD12, more particularly MXD10.

In one embodiment, said semi-aromatic polyamide excludes 2-pyrrolidone units.

### The Phosphinate Flame Retardant (c)

Said at least one phosphinate flame retardant (c) is present at from 15 to 30%, more particularly from 20 to 25%, by weight in the composition.

The flame retardant is in particular a metal salt chosen from a metal salt of phosphinic acid, a metal salt of diphosphinic acid, a polymer containing at least one metal salt of phosphinic acid and a polymer containing at least one metal salt of diphosphinic acid. The flame retardant may also be a mixture of the aforesaid flame retardants.

The flame retardant may also be chosen from the metal salt of phosphinic acid of formula (I) below and the metal salt of diphosphinic acid of formula (II) below:

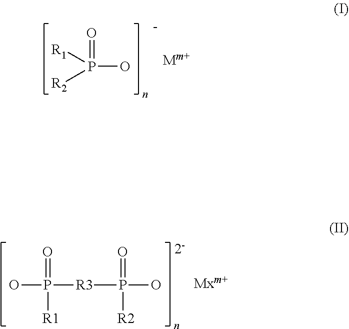

with
R1 and R2, independently of each other, denote a linear or branched C1-C6 alkyl group or an aryl group;
R3 is a linear or branched C1-C10 alkylene, C6-C10 arylene, C6-C10 alkylarylene or C6-C10 arylalkylene group,
M is an Mg, Ca, Al, Sb, Sn, Ge, Ti, Zn, Fe, Zr, Ce, Bi, Sr, Mn, Li, Na or K ion and/or a protonated amine base,
m denotes an integer from 1 to 4,
n denotes an integer from 1 to 4,
x denotes an integer from 1 to 4,
n and m being chosen such that the salt is neutral, that is to say that it does not carry an electrical charge.

Preferably, M is a calcium, magnesium, aluminum or zinc ion.

Preferably, R1 and R2, independently of each other, denote a methyl, ethyl, n-propyl, isopropyl, n-butyl, tert-butyl, n-pentyl and/or phenyl group.

Preferably, R3 is a methylene, ethylene, n-propylene, isopropylene, n-butylene, tert-butylene, n-pentylene, n-octylene, n-dodecylene; phenylene, naphthylene; methylphenylene, ethylphenylene, tert-butylphenylene, methylnaphthylene, ethylnaphthylene, tert-butylnaphthylene; phenylmethylene, phenylethylene, phenylpropylene or phenylbutylene group.

### The Functionalized Polyolefin (d)

Said at least one functionalized polyolefin (d) is present at from 5 to 20%, more particularly from 5 to 15%, by weight in the composition.

The functionalized polyolefin may be a polymer of alpha olefins having reactive units (the functionalities); such reactive units are the acid, anhydride or epoxy functions. By way of example, mention may be made of the preceding polyolefins (B2) grafted or copolymerized or terpolymerized with unsaturated epoxides, such as glycidyl (meth) acrylate, or with carboxylic acids or the corresponding salts or esters, such as (meth) acrylic acid (it being possible for the latter to be completely or partially neutralized with metals such as Zn, and the like), or else with carboxylic acid anhydrides, such as maleic anhydride. A functionalized polyolefin is, for example, a PE/EPR mixture, the weight ratio of which can vary within broad limits, for example between 40/60 and 90/10, said mixture being cografted with an anhydride, notably maleic anhydride, in a degree of grafting of, for example, from 0.01 to 5% by weight.

The functionalized polyolefin may be chosen from the following (co) polymers grafted with maleic anhydride or glycidyl methacrylate, in which the degree of grafting is, for example, from 0.01 to 5% by weight:
PE, PP, copolymers of ethylene with propylene, butene, hexene or octene containing, for example, from 35 to 80% by weight of ethylene;
ethylene/alpha-olefin such as ethylene/propylene, EPR (abbreviation for ethylene-propylene-rubber) and ethylene/propylene/diene (EPDM) copolymers.
   styrene/ethylene-butene/styrene (SEBS), styrene/butadiene/styrene (SBS), styrene/isoprene/styrene (SIS) and styrene/ethylene-propylene/styrene (SEPS) block copolymers.
copolymers of ethylene and vinyl acetate (EVA), containing up to 40% by weight of vinyl acetate;
copolymers of ethylene and alkyl (meth) acrylate, containing up to 40% by weight of alkyl (meth) acrylate;
copolymers of ethylene and vinyl acetate (EVA) and alkyl (meth) acrylate, containing up to 40% by weight of comonomers.

The functionalized polyolefin may also be chosen from majority-propylene ethylene/propylene copolymers which are grafted with maleic anhydride and then condensed with monoaminated polyamide (or a polyamide oligomer) (products described in EP-A-0342066).

The functionalized polyolefin may also be a co- or terpolymer of at least the following units: (1) ethylene, (2) alkyl (meth) acrylate or saturated carboxylic acid vinyl ester and (3) anhydride, such as maleic or (meth) acrylic acid anhydride, or epoxy, such as glycidyl (meth) acrylate.

As examples of functionalized polyolefins of the latter type, mention may be made of the following copolymers, where ethylene preferably represents at least 60% by weight and where the termonomer (the function) represents, for example, from 0.1 to 10% by weight of the copolymer:
ethylene/alkyl (meth) acrylate/(meth) acrylic acid or maleic anhydride or glycidyl methacrylate copolymers;
ethylene/vinyl acetate/maleic anhydride or glycidyl methacrylate copolymers;
ethylene/vinyl acetate or alkyl (meth) acrylate/(meth) acrylic acid or maleic anhydride or glycidyl methacrylate copolymers.

In the preceding copolymers, the (meth) acrylic acid can be salified with Zn or Li.

The term “alkyl (meth) acrylate” denotes C1 to C8 alkyl methacrylates and acrylates, and may be chosen from methyl acrylate, ethyl acrylate, n-butyl acrylate, isobutyl acrylate, 2-ethylhexyl acrylate, cyclohexyl acrylate, methyl methacrylate and ethyl methacrylate.

Moreover, the abovementioned functionalized polyolefins can also be crosslinked by any appropriate process or agent (diepoxy, diacid, peroxide, etc.); the term functionalized polyolefin also includes mixtures of the abovementioned polyolefins with a difunctional reagent such as diacid, dianhydride, diepoxy, etc. capable of reacting with them, or mixtures of at least two functionalized polyolefins capable of reacting with each other.

The copolymers mentioned above may be copolymerized randomly or sequentially and may have a linear or branched structure.

The molecular weight, the MFI index and the density of these polyolefins may also vary within a broad range, which will be perceived by a person skilled in the art. MFI is the abbreviation for the Melt Flow Index. It is measured according to the standard ASTM 1238.

In one embodiment, the polyolefin is crosslinked.

The plasticizer (e)

Said at least one plasticizer (e) may be present at from 0 to 6%, more particularly from 1 to 6%, in particular between 2 and 4%, by weight in the composition.

The plasticizer can be a plasticizer commonly used in compositions based on polyamide(s).

Advantageously, use is made of a plasticizer which exhibits good thermal stability in order for fumes not to be formed during the stages of mixing the various polymers and of transformation of the composition obtained.

In particular, this plasticizer can be chosen from:

benzenesulfonamide derivatives such as n-butylbenzenesulfonamide (BBSA), ortho and para isomers of ethyltoluenesulfonamide (ETSA), N-cyclohexyltoluenesulfonamide and N-(2-hydroxypropyl) benzenesulfonamide (HP-BSA), esters of hydroxybenzoic acids such as 2-ethylhexyl para-hydroxybenzoate (EHPB) and 2-decylhexyl para-hydroxybenzoate (HDPB), esters or ethers of tetrahydrofurfuryl alcohol such as oligoethyleneoxy-tetrahydrofurfuryl alcohol, and esters of citric acid or hydroxymalonic acid, such as oligoethyleneoxymalonate.

A preferred plasticizer is n-butylbenzenesulfonamide (BBSA).

Another more particularly preferred plasticizer is N-(2-hydroxypropyl) benzenesulfonamide (HP-BSA). This is because the latter exhibits the advantage of preventing the formation of deposits at the extrusion screw and/or die (“die drool”) during a stage of transformation by extrusion.

Use may very obviously be made of a mixture of plasticizers.

The additives (f)

Said at least one additive (f) may be present at from 0 to 10%, more particularly from 0.1 to 5%, by weight in the composition.

The at least one additive may be chosen from stabilizers, dyes, adjuvants assisting in the transformation (processing aids), surfactants, nucleating agents, pigments, brighteners, antioxidants, lubricants, waxes, flame retardancy synergists, or a mixture thereof. By way of example, the stabilizer may be a UV stabilizer, an organic stabilizer or more generally a combination of organic stabilizers, such as an antioxidant of phenol type (for example of the type of Irganox® 245 or 1098 or 1010 from Ciba-BASF), or an antioxidant of phosphite type (for example Irgafos® 126 or Irgafos® 168 from Ciba-BASF) and even optionally other stabilizers such as a HALS, which means hindered amine light stabilizer (for example Tinuvin® 770 from Ciba-BASF), an anti-UV agent (for example Tinuvin® 312 from Ciba) or a phosphorus-based stabilizer. Use may also be made of antioxidants of amine type, such as Naugard® 445 from the company Crompton or else polyfunctional stabilizers, such as Nylostab® S-EED from the company Clariant.

This stabilizer may also be a mineral stabilizer, such as a copper-based stabilizer. Examples of such mineral stabilizers that may be mentioned include copper acetates and halides. Incidentally, other metals, such as silver, may possibly be considered, but said metals are known to be less effective. These copper-based compounds are typically combined with halides of alkali metals, in particular potassium.

The flame retardancy synergistic agents are in particular as described in WO 2005121234.

They may be chosen from nitrogen synergists and phosphorus/nitrogen synergists.

The nitrogen synergists preferably include benzoguanamine, tris(hydroxyethyl) isocyanurate, allantoin, glycoluril, melamine, melamine cyanurate, dicyandiamide, guanidine and carbodiimides.

The nitrogen synergists preferably comprise melamine condensation products. By way of example, the condensation products of melamine are melem, melam or melon, or compounds of this type with a higher degree of condensation, or a mixture thereof, and, by way of example, can be prepared by the process described in U.S. Pat. No. 5,985,960.

The phosphorus/nitrogen synergists may comprise reaction products of melamine with phosphoric acid or condensed phosphoric acids, or comprise reaction products of melamine condensation products with phosphoric acid or condensed phosphoric acids, or comprise a mixture of the specified products.

In one embodiment, the additives are chosen from antioxidants, colored pigments and flame retardancy synergists, in particular nitrogen synergists, more particularly melamine-based synergists.

### The Composition

Said flame retarded insulating composition for covering electric battery busbars comprises by weight:
(a) from 30 to 65%, more particularly from 30 to 63.9%, in particular from 30 to 60%, of at least one semi-crystalline aliphatic polyamide,
(b) from 15 to 40%, more particularly from 15 to 30%, of at least one semi-aromatic polyamide,
(c) from 15 to 30%, more particularly from 20 to 25%, of at least one phosphinate flame retardant,
(d) from 5 to 20%, more particularly from 5 to 15%, of at least one functionalized polyolefin,
(e) from 0 to 6%, more particularly from 1 to 6%, in particular from 2 to 4%, of at least one plasticizer,
(f) from 0 to 10%, more particularly from 0.1 to 5%, of at least one additive,
the sum of the constituents (a) to (f) being equal to 100%.

Advantageously, said insulating and flame retarded composition for covering electric battery busbars consists by weight of:
(a) from 30 to 65%, more particularly from 30 to 63.9%, in particular from 30 to 60% of at least one semi-crystalline aliphatic polyamide,
(b) from 15 to 40%, more particularly from 15 to 30%, of at least one semi-aromatic polyamide,
(c) from 15 to 30%, more particularly from 20 to 25%, of at least one phosphinate flame retardant,
(d) from 5 to 20%, more particularly from 5 to 15%, of at least one functionalized polyolefin,
(e) from 0 to 6%, more particularly from 1 to 6%, in particular from 2 to 4%, of at least one plasticizer,
(f) from 0 to 10%, more particularly from 0.1 to 5%, of at least one additive, the sum of the constituents (a) to (f) being equal to 100%.

In a first variant, said composition comprises by weight:
(a) from 30 to 64%, in particular from 30 to 60%, of at least one semi-crystalline aliphatic polyamide,
(b) from 15 to 40%, more particularly from 15 to 30%, of at least one semi-aromatic polyamide,
(c) from 15 to 30%, more particularly from 20 to 25%, of at least one phosphinate flame retardant,
(d) from 5 to 20%, more particularly from 5 to 15%, of at least one functionalized polyolefin,
(e) from 1 to 6%, in particular between 2 and 4%, of at least one plasticizer,
(f) from 0 to 10%, more particularly from 0.1 to 5%, of at least one additive, the sum of the constituents (a) to (f) being equal to 100%.

In one embodiment of this first variant, said composition comprises by weight:
(a) from 30 to 64%, in particular from 30 to 60%, of at least one semi-crystalline aliphatic polyamide,
(b) from 15 to 30% of at least one semi-aromatic polyamide,
(c) from 15 to 30%, more particularly from 20 to 25%, of at least one phosphinate flame retardant,
(d) from 5 to 20%, more particularly from 5 to 15%, of at least one functionalized polyolefin,
(e) from 1 to 6%, in particular between 2 and 4%, of at least one plasticizer,
(f) from 0 to 10%, more particularly from 0.1 to 5%, of at least one additive, the sum of the constituents (a) to (f) being equal to 100%.

Advantageously, said composition comprises by weight:
(a) from 30 to 59% of at least one semi-crystalline aliphatic polyamide,
(b) from 15 to 30% of at least one semi-aromatic polyamide,
(c) from 20 to 25% of at least one phosphinate flame retardant,
(d) from 5 to 20%, more particularly from 5 to 15%, of at least one functionalized polyolefin,
(e) from 1 to 6%, in particular between 2 and 4%, of at least one plasticizer,
(f) from 0 to 10%, more particularly from 0.1 to 5%, of at least one additive, the sum of the constituents (a) to (f) being equal to 100%.

More advantageously, said composition comprises by weight:
(a) from 30 to 64%, in particular from 30 to 60%, of at least one semi-crystalline aliphatic polyamide,
(b) from 15 to 30% of at least one semi-aromatic polyamide,
(c) from 15 to 30%, more particularly from 20 to 25%, of at least one phosphinate flame retardant,
(d) from 5 to 15% of at least one functionalized polyolefin,
(e) from 1 to 6%, in particular between 2 and 4%, of at least one plasticizer,
(f) from 0 to 10%, more particularly from 0.1 to 5%, of at least one additive,
the sum of the constituents (a) to (f) being equal to 100%.

Even more advantageously, said composition comprises by weight:
(a) from 30 to 59% of at least one semi-crystalline aliphatic polyamide,
(b) from 15 to 30% of at least one semi-aromatic polyamide,
(c) from 20 to 25% of at least one phosphinate flame retardant,
(d) from 5 to 15% of at least one functionalized polyolefin,
(e) from 1 to 6%, in particular between 2 and 4%, of at least one plasticizer,
(f) from 0 to 10%, more particularly from 0.1 to 5%, of at least one additive, the sum of the constituents (a) to (f) being equal to 100%.

Even more advantageously, said composition comprises by weight:
(a) from 30 to 58.9% of at least one semi-crystalline aliphatic polyamide,
(b) from 15 to 30% of at least one semi-aromatic polyamide,
(c) from 20 to 25% of at least one phosphinate flame retardant,
(d) from 5 to 15% of at least one functionalized polyolefin,
(e) from 1 to 6%, in particular between 2 and 4%, of at least one plasticizer,
(f) from 0.1 to 5% of at least one additive,
the sum of the constituents (a) to (f) being equal to 100%.

In a second variant, said composition comprises by weight:
(a) from 30 to 59% of at least one semi-crystalline aliphatic polyamide,
(b) from 15 to 40%, more particularly from 15 to 30%, of at least one semi-aromatic polyamide,
(c) from 20 to 25% of at least one phosphinate flame retardant,
(d) from 5 to 20%, more particularly from 5 to 15%, of at least one functionalized polyolefin,
(e) from 1 to 6%, in particular between 2 and 4%, of at least one plasticizer,
(f) from 0 to 10%, more particularly from 0.1 to 5%, of at least one additive, the sum of the constituents (a) to (f) being equal to 100%.

In one embodiment of this second variant, said composition comprises by weight:
(a) from 30 to 59% of at least one semi-crystalline aliphatic polyamide,
(b) from 15 to 40%, more particularly from 15 to 30%, of at least one semi-aromatic polyamide,
(c) from 20 to 25% of at least one phosphinate flame retardant,
(d) from 5 to 15% of at least one functionalized polyolefin,
(e) from 1 to 6%, in particular between 2 and 4%, of at least one plasticizer,
(f) from 0 to 10%, more particularly from 0.1 to 5%, of at least one additive, the sum of the constituents (a) to (f) being equal to 100%.

In another embodiment of this second variant, said composition comprises by weight:
(a) from 30 to 58.9% of at least one semi-crystalline aliphatic polyamide,
(b) from 15 to 40%, more particularly from 15 to 30%, of at least one semi-aromatic polyamide,
(c) from 20 to 25% of at least one phosphinate flame retardant,
(d) from 5 to 20%, more particularly from 5 to 15%, of at least one functionalized polyolefin,
(e) from 1 to 6%, in particular between 2 and 4%, of at least one plasticizer,
(f) from 0.1 to 5% of at least one additive,
the sum of the constituents (a) to (f) being equal to 100%.

In a third variant, said composition comprises by weight:
(a) from 30 to 64%, in particular from 30 to 60%, of at least one semi-crystalline aliphatic polyamide,
(b) from 15 to 40%, more particularly from 15 to 30%, of at least one semi-aromatic polyamide,
(c) from 15 to 30%, more particularly from 20 to 25%, of at least one phosphinate flame retardant,
(d) from 5 to 15% of at least one functionalized polyolefin,
(e) from 1 to 6%, in particular between 2 and 4%, of at least one plasticizer,
(f) from 0 to 10%, more particularly from 0.1 to 5%, of at least one additive, the sum of the constituents (a) to (f) being equal to 100%.

In one embodiment of this third variant, said composition comprises by weight:
(a) from 30 to 64%, in particular from 30 to 60%, of at least one semi-crystalline aliphatic polyamide,
(b) from 15 to 40%, more particularly from 15 to 30%, of at least one semi-aromatic polyamide,
(c) from 15 to 30%, more particularly from 20 to 25%, of at least one phosphinate flame retardant,
(d) from 5 to 15% of at least one functionalized polyolefin,
(e) from 1 to 6%, in particular between 2 and 4%, of at least one plasticizer,
(f) from 0 to 10%, more particularly from 0.1 to 5%, of at least one additive, the sum of the constituents (a) to (f) being equal to 100%.

In another embodiment of this third variant, said composition comprises by weight:
(a) from 30 to 63.9%, in particular from 30 to 60%, of at least one semi-crystalline aliphatic polyamide,
(b) from 15 to 40%, more particularly from 15 to 30%, of at least one semi-aromatic polyamide,
(c) from 15 to 30%, more particularly from 20 to 25%, of at least one phosphinate flame retardant,
(d) from 5 to 15% of at least one functionalized polyolefin,
(e) from 1 to 6%, in particular between 2 and 4%, of at least one plasticizer,
(f) from 0.1 to 5% of at least one additive,
the sum of the constituents (a) to (f) being equal to 100%.

Advantageously, whatever the embodiments of these three variants, the present invention covers the same compositions which consist of instead of comprising constituents (a) to (f), the sum of said constituents (a) to (f) being equal to 100%.

In one embodiment, the composition defined above has an elongation at break >50%.

In another embodiment, the composition defined above has a stress at the threshold of <20 MPa, preferably <17 MPa, more preferably <14 MPa.

In yet another embodiment, the composition defined above has an elongation at the threshold >3%, preferably >5%, more preferably >10%.

In another embodiment, the composition defined above has an elongation at break >50% and a stress at the threshold <20 MPa, preferably <17 MPa, more preferably <14 MPa.

In another embodiment, the composition defined above has an elongation at break >50% and an elongation at the threshold >3%, preferably >5%, more preferably >10%.

In another embodiment, the composition defined above has an elongation at break >50%, a stress at the threshold <20 MPa, preferably <17 MPa, more preferably <14 MPa and an elongation at the threshold >3%, preferably >5%, more preferably >10%.

Advantageously, said composition exhibits good abrasion resistance as measured according to the standard ISO 9352:2012. Advantageously, the compositions of the invention after covering have an electrical insulator role with a breakdown voltage as measured according to the standard IEC 60243-1.

Advantageously, the compositions defined above have a high dielectric strength (>5 kV/mm at 90° C.) as measured according to the standard IEC 60243-1.

Advantageously, the compositions defined above have a dielectric strength of greater than 40 kV/mm at 23° C., preferably greater than 50 kV/mm.

Advantageously, the compositions defined above exhibit a comparative tracking index (CTI)>600 V as measured according to IEC60112. This insulation is preserved during accelerated thermal aging at possibly up to 150° C.

Advantageously, the compositions of the invention after covering have an electrical insulator role with a breakdown voltage for a thickness of 500 μm>30 kV in direct current (DC) and >15 kV in alternating current (AC) and a comparative tracking index (CTI)>600 V.

Advantageously, the compositions of the invention after covering have a dielectric strength >5 kV/mm at 90° C. and a comparative tracking index (CTI)>600 V.

Advantageously, the compositions of the invention after covering have an electrical insulator role with a dielectric strength at 23° C. of greater than 40 kV/mm, preferably greater than 50 kV/mm, and a comparative tracking index (CTI)>600 V.

Said composition of the invention is fire resistant and has a result V0 in the UL94 fire test with a thickness of 0.8 mm.

### The PEBA Possibly Excluded

In one embodiment, said composition is free of polyether block amides (PEBA).

The polyether block amides (PEBA) are copolymers containing amide units (Ba1) and polyether units (Ba2), said amide unit (Ba1) corresponding to an aliphatic repeating unit chosen from a unit obtained from at least one amino acid or a unit obtained from at least one lactam, or a unit X.Y obtained from the polycondensation of:
at least one diamine, said diamine being chosen from a linear or branched aliphatic diamine or an aromatic diamine or a mixture thereof, and
at least one carboxylic diacid, said diacid being chosen from an aliphatic diacid or an aromatic diacid,
said polyether units (Ba2) being obtained in particular from at least one polyalkylene ether polyol, in particular a polyalkylene ether diol.

### The Reinforcing Fibers Possibly Excluded

In one embodiment the reinforcing fibers, said composition is free of reinforcing fibers chosen from glass fibers, carbon fibers, basalt fibers and basalt-based fibers.

In another embodiment, said composition is free of reinforcing fibers chosen from reinforcing fibers of mineral, organic or vegetable origin.

Mention may be made, among the fibers of mineral origin, of carbon fibers, glass fibers, basalt fibers or basalt-based fibers, silica fibers or silicon carbide fibers, for example. Mention may be made, among the fibers of organic origin, of fibers based on thermoplastic or thermosetting polymer, such as semi-aromatic polyamide fibers, aramid fibers or polyolefin fibers, for example. Mention may be made, among the fibers of vegetable origin, of natural fibers based on flax, hemp, lignin, bamboo, silk, in particular spider silk, sisal, and other cellulose fibers, in particular viscose fibers.

According to another aspect, the present invention relates to the use of a composition as defined above, for covering, insulating and flame retarding an electric battery busbar.

All of the characteristics defined above are valid for this use.

The composition of the invention makes it possible to cover the busbar with a thin layer of from 0.1 mm to 2 mm, more particularly from 0.2 mm to 1 mm, in particular from 0.3 mm to 0.8 mm, more specifically from 0.4 mm to 0.6 mm, while maintaining a high level of flexibility to accommodate deformation of the busbars.

A material that is too rigid forms cracks or “waves” that are unacceptable for the application.

In one embodiment, said busbar is located inside and/or outside electric batteries, more particularly electric batteries of a vehicle, more particularly of a motor vehicle.

According to yet another aspect, the present invention relates to a process for producing a covered, insulated and flame retarded electric battery busbar, comprising a step of extruding a composition as defined above onto an electric battery busbar, or a step of powder coating said composition onto an electric battery busbar.

All of the characteristics defined above are valid for the process.

In one embodiment, said busbar is located inside and/or outside electric batteries, more particularly electric batteries of a vehicle, more particularly of a motor vehicle.

The present invention will now be illustrated by non-limiting examples of the scope of the invention.

### EXAMPLES

The compositions of Table 1 were prepared by melt blending polymer pellets with the flame retardants and the additives. This blending was carried out by compounding on a co-rotating twin-screw extruder with a diameter of 40 mm with a flat temperature profile (T°) at 250° C. The screw speed is 300 rpm and the throughput is 70 kg/h.

The polyamide(s), the polyolefins and the additives are introduced during the compounding process in the main hopper. The flame retardant is added to the molten polymer, in the middle of the screw via a side feeder. If plasticizer is present, it is also introduced into the molten polymer via a pump.

The compositions were then extruded in the form of 0.8 mm films by cast extrusion at a speed of 1 m/min and with temperature setpoints of 230° C. for the extruder and 65° C. for the rolls on which the film is recovered in order to study the mechanical properties and the fire resistance according to the standards below.

The samples tested are die-cut from this film.

Elongation and stress at the threshold and at break were measured at 23° C. according to the standard ISO 527-1:2012 on a dry sample, a dumbbell cut from the 0.8 mm thickness film.

An Instron 5966 machine is used. The speed of the crosspiece is 50 mm/min.

The test conditions are 23° C.+/−2° C., on dry samples.

The compositions of the invention and comparative compositions were tested with a flame propagation test usually carried out and called UL94 according to the NFT 51072 standard and carried out on test pieces 0.8 mm thick.

TABLE 1

| | Example of the invention (EI) or comparative example (EC) | | | | | | | |
|---|---|---|---|---|---|---|---|---|
| | EC1 | EI1 | EI2 | EC2 | EC3 | EC4 | EC5 | EC6 |
| PA 11 | 43.4 | 44 | 41 | 46 | 41 | 36 | 41 | 54 |
| MXD10 | | 20 | 20 | 20 | 20 | 20 | 10 | 20 |
| Lotader ® | 5 | 5 | 5 | 5 | 5 | 5 | 5 | — |
| 4700 | | | | | | | | |
| Lotader ® | 2.5 | 2.5 | 2.5 | 2.5 | 2.5 | 2.5 | 2.5 | — |
| AX8900 | | | | | | | | |
| Escor ® 5000 | 2.5 | 2.5 | 2.5 | 2.5 | 2.5 | 2.5 | 2.5 | — |
| Exolit ® | 25 | 25 | 25 | — | — | — | 25 | 25 |
| OP1311 | | | | | | | | |
| Melapur | | — | — | 20 | 25 | 30 | — | — |
| MC25 | | | | | | | | |
| BBSA | | — | 3 | 3 | 3 | 3 | 3 | — |
| Lowinox | 0.8 | 0.8 | 0.8 | 0.8 | 0.8 | 0.8 | 0.8 | 0.8 |
| 44B25 | | | | | | | | |
| Alkanox 240 | 0.2 | 0.2 | 0.2 | 0.2 | 0.2 | 0.2 | 0.2 | 0.2 |
| UL94 fire test | | | | | | | | |
| Observation | Creep and | Flame | Flame | Total | Total | Total | Creep and | Flame |
| | flaming | persistence <10 s | persistence <10 s | combustion | combustion | combustion | flaming | persistence <10 s |
| | drops | | | | | | drops | |
| Classification | V-2 | V-0 | V-0 | NC | NC | NC | V-2 | V0 |

Voltage test @ 23° C. 50 mm/min

| | | | | | | | | |
|---|---|---|---|---|---|---|---|---|
| Elongation at | 4.3 | 3.6 | 12.4 | 5.3 | 5.1 | 2.5 | 3.9 | 2.7 |
| the threshold | | | | | | | | |
| (%) | | | | | | | | |
| Stress at the | 20.4 | 18.1 | 13.0 | 28.0 | 27.0 | 19.0 | 19.1 | 23 |
| threshold | | | | | | | | |
| (MPa) | | | | | | | | |
| Elongation at | 37 | 57 | 105 | 29 | 19 | 18 | 43 | 34 |
| break (%) | | | | | | | | |
| Tensile | 20.0 | 17.7 | 13.0 | 23.0 | 23.0 | 17.0 | 18.8 | 21.8 |
| strength | | | | | | | | |
| (MPa) | | | | | | | | |

The dielectric strength of the alloy according to the invention EI1 was measured at 12 kV at 90° C., higher than the target set at 5 kV. The invention therefore also satisfies the requirement of electrical insulation.

### NC: Unclassified

PA 11 is an Arkema PA 11 of viscosity 1.35.

MXD10 is an Arkema PA of viscosity 0.9 derived from the polycondensation of m-xylenediamine and sebacic acid.

Exolit® OP1311 is a Clariant product (flame retardant based on aluminum diethyl phosphinate).

BBSA (benzylbutylsulfonamide)

Lotader AX8900: copolymer of ethylene, methyl acrylate and glycidyl methacrylate (Et/MA/GMA-68/24/8 by weight) (SK functional polymer).

Lotader 4700: copolymer of ethylene, ethyl acrylate and maleic anhydride (Et/EA/MAH-69/30/1 by weight) (SK functional polymer).

Escor® 5000: ethylene-acrylic acid copolymer (Exxon Mobil chemicals)

Lowinox® 44B25 (CAS No.: 85-60-9), phenolic primary antioxidant.

Alkanox® 240 (CAS No.: 31570-04-4), phosphite secondary antioxidant (Bren

Melapur® MC25: melamine cyanurate-based flame retardant (BASF)

Table 1 above shows that the compositions of the invention EI1 and EI2 exhibit a result V0 in the UL94 test, unlike the comparative composition EC1, which does not have MXD10, or the comparative composition EC5, which has an amount of MXD10 of less than 15%.

In addition, only the compositions of the invention exhibit an elongation at break >50%, unlike the comparative composition EC1, which does not have MXD10, or the comparative composition EC5, which has an amount of MXD10 of less than 15%, or the composition EC6, which does not have polyolefins, or comparative compositions EC2 to 4, which have an amount of MXD10 of greater than 15% but whose flame retardant is not of phosphinate type.

The compositions of the invention also exhibit a stress at the threshold of <20 MPa and an elongation at the threshold of >3%, unlike EC6, which does not contain polyolefins.

1. A flame retarded insulating composition for covering electric battery busbars, comprising by weight:
(a) from 30 to 65% of at least one semi-crystalline aliphatic polyamide,
(b) from 15 to 40% of at least one semi-aromatic polyamide,
(c) from 15 to 30% of at least one phosphinate flame retardant,
(d) from 5 to 20% of at least one functionalized polyolefin,
(e) from 0 to 6% of at least one plasticizer,
(f) from 0 to 10% of at least one additive, the sum of the constituents (a) to (f) being equal to 100%.

2. The composition as claimed in claim 1, wherein the polyamide is a long-chain polyamide having a number of carbons per nitrogen atom of greater than or equal to 8.

3. The composition as claimed in claim 2, wherein said long-chain polyamide is chosen from PA610, PA612, PA1010, PA1012, PA11 and PA12.

4. The composition as claimed in claim 1, wherein said at least one semi-crystalline aliphatic polyamide is chosen from PA1010, PA1012, PA11 and PA12.

5. The composition as claimed in claim 1, wherein said semi-aromatic polyamide is a polyamide of formula MXDY in which MXD corresponds to meta-xylylenediamine and Y is a C6 to C18 aliphatic dicarboxylic acid.

6. The composition as claimed in claim 5, wherein said semi-aromatic polyamide of formula MXDY is chosen from MXD6, MXD10 and MXD12.

7. The composition as claimed in claim 16, wherein the flame retardant is a metal salt chosen from a metal salt of phosphinic acid, a metal salt of diphosphinic acid, a polymer containing at least one metal salt of phosphinic acid and a polymer containing at least one metal salt of diphosphinic acid.

8. The composition as claimed in claim 1, wherein the polyolefin is crosslinked.

9. The composition as claimed in claim 1, wherein the additives are chosen from antioxidants, colored pigments and flame retardancy synergists.

10. The composition as claimed in claim 1, wherein the composition is free of polyether block amides (PEBA).

11. The composition as claimed in claim 1, wherein the composition is free of reinforcing fibers.

12. A method of using a composition as defined in claim 1 for covering, insulating and flame retarding an electric battery busbar.

13. The method as claimed in claim 12, wherein said busbar is located inside and/or outside electric batteries.

14. A process for producing a covered, insulated and flame retarded electric battery busbar, comprising a step of extruding a composition as defined in claim 1 onto an electric battery busbar, or a step of powder coating said composition onto an electric battery busbar.
